(19) United States
(12) Patent Application Publication
(10) Pub. No.: US 2014/0217134 A1
(43) Pub. Date: Aug. 7, 2014

(54) METHOD AND SYSTEM FOR MAINTAINING JETTING STABILITY IN A JETTING DEVICE

(71) Applicant: OCE-TECHNOLOGIES B.V., Venlo (NL)

(72) Inventor: Mircea V. RASA, Eindhoven (NL)

(73) Assignee: OCE-TECHNOLOGIES B.V., Venlo (NL)

(21) Appl. No.: 14/245,031

(22) Filed: Apr. 4, 2014

Related U.S. Application Data
(63) Continuation of application No. PCT/EP2012/068512, filed on Sep. 20, 2012.

(30) Foreign Application Priority Data
Oct. 6, 2011 (EP) 11184119.3

(51) Int. Cl. B05B 5/16

(52) U.S. Cl. CPC B05B 5/1608
USPC 222/590; 222/594

(57) ABSTRACT

The invention relates to a method for maintaining and/or restoring the jetting stability in a jetting device, the jetting comprising fluid chamber body having arranged therein an orifice, the jetting device being configured to comprise a quantity of an electrically conductive fluid. The jetting device comprises actuation means, comprising a magnetic field generating means and an electrical current generating means for, in operation, applying an actuation pulse to the electrically conductive fluid. The method for maintaining and/or restoring the jetting stability comprises applying an maintenance pulse to at least a part of the electrically conductive fluid. The invention further relates to a jetting device, employing the described method.

The present invention relates to a method and a system for jetting electrically conductive fluids and more in particular to a method and a system for maintaining jetting stability in said system.

### BACKGROUND OF THE INVENTION

A jetting device for ejecting droplets of an electrically conductive fluid, such as a molten metal or a molten semiconductor is known. An example of a jetting device for ejecting droplets of an electrically conductive fluid is described in WO 2010/063576 A1. In such a printing device, a Lorentz force is generated in the electrically conductive fluid due to which a droplet is expelled through an orifice nozzle of the printing device. Such a device may be used for ejecting droplets of a fluid having a high temperature, for example a molten metal having a high melting point.

Direct printing of molten metals may be employed for printing electronic circuitry, for example. In such an application it is essential that all droplets are actually printed accurately as otherwise the electronic circuitry may not function due to an interruption in the electronic connections as a result of a missing droplet, for example. Therefore, it is desirable that all droplets are actually generated. Thus, jetting stability has to be maintained. However, the jetting stability may decrease during the jetting process, for example by (partial) blocking of an orifice. An orifice may be blocked, for example by impurities that have build up in the orifice, or by (partial) solidification of the electrically conductive fluid in the proximity of the orifice. When an orifice is blocked, it may be more difficult or even impossible to eject a droplet of fluid from the orifice. As a consequence, a decrease in the jetting stability may therefore result in missing droplets.

It is therefore desirable to maintain or—if necessary—restore the jetting stability. It is known to restore the jetting stability of a jetting device by purging the orifice. The orifice may be purged by applying a purge pulse. U.S. Pat. No. 4,245,224 discloses a piezoelectric jetting device for jetting droplets of ink, wherein the jetting stability may be restored by applying a purge pulse. The purge pulse may apply a larger force to the fluid than a regular actuation pulse and/or the purge pulse may be maintained longer than a regular actuation pulse. Also in jetting devices for jetting an electrically conductive fluid, wherein the fluid is jetted using Lorentz actuation, a purge pulse may be applied. However, it was found that applying a positive purge pulse does not always result in restoring the jetting stability in a device for jetting an electrically conductive fluid.

It is an object of the invention to provide a method for maintaining the jetting stability of a jetting device.

### SUMMARY OF THE INVENTION

The above object is achieved in a method for maintaining jetting stability in a jetting device for jetting a droplet of an electrically conductive fluid, the jetting device comprising a fluid chamber body defining a fluid chamber and having an orifice extending from the fluid chamber to an outer surface of the fluid chamber element and an actuation means, the actuation means comprising:
a magnetic field generating means for generating a magnetic field in at least a part of the fluid chamber; and
an electrical current generating means for generating an electrical current in the electrically conductive fluid in the part of the fluid chamber provided with the magnetic field,
the actuation means being configured to provide an actuation pulse for expelling droplets of the electrically conductive fluid from the fluid chamber through the orifice, the actuation means being further configured to provide a maintenance pulse, the actuation pulse and the maintenance pulse each generating a Lorentz force in the conductive fluid in said part of the fluid chamber,
the method comprising the step of:
a) applying the maintenance pulse to at least a part of the electrically conductive fluid in the part of the chamber provided with the magnetic field, the maintenance pulse being configured to retract a meniscus of the electrically conductive fluid into the fluid chamber.

In a known system for printing an electrically conductive fluid, a droplet of said electrically conductive fluid is expelled through an orifice by a Lorentz force. This force causes a motion in the conductive fluid. This motion may cause a part of the fluid to move from the fluid chamber through the orifice, thereby generating a droplet of the fluid. The Lorentz force is related to the electric current and the magnetic field vector; \vec{F}=\vec{I}×\vec{B}. The Lorentz force resulting from the electric current and the magnetic field is generated in a direction perpendicular to both the electrical current and the magnetic field. By suitably selecting the direction and the magnitude of the electric current, as well as the direction and the magnitude of the magnetic field, the direction and the magnitude of the resulting Lorentz force may be selected. In the system according to the present invention, in normal operation, the magnetic field is provided and an electrical current is provided in the conductive fluid, such that a suitable force for ejecting a droplet is generated.

The jetting device in accordance with the present invention comprises a fluid chamber and has an orifice extending from the fluid chamber to an outer surface of the fluid chamber element. In operation, the fluid chamber comprises an electrically conductive fluid. The electrically conductive fluid may be a molten metal or a molten semiconductor. In addition, the fluid may be a mixture of molten metals, a mixture of molten semiconductors or a mixture of at least one molten metal and at least one molten semiconductor. For example, droplets of molten silver, molten gold, molten copper or molten solder may be jetted using the jetting device in accordance with the present invention. The electrically conductive fluids may be essentially free of solvents; thus, the metal or semiconductor does not need to be dissolved, but may be jetted in its essentially pure (molten) form. If the fluid is essentially free of solvents, no changes in composition of the fluid may occur due to evaporation of the solvent. As a consequence, the composition of the fluid in the fluid chamber, as well as its properties, may not change with time.

When applying an actuation pulse, a Lorentz force is generated within the fluid, causing the fluid to move through the orifice in a direction away from the fluid chamber. The actuation pulse may be applied by applying a pulsed magnetic field and a continuous electrical current, or a pulsed electrical current in a continuous magnetic field, or a combination thereof. Alternatively, a constant Lorentz force may be generated within the fluid by applying a constant electrical current to the electrically conductive fluid in a constant magnetic field. However, application of a constant Lorentz force to the electrically conductive fluid may result in the ejection of a stream of the electrically conductive fluid, instead of in the ejection of droplets.

The actuation pulse, provided by a pulse of electrical current or a pulse of a magnetic field, or both, may have any shape or magnitude, provided that the actuation pulse is suited to, in normal operation of the jetting device, provide a force in the electrically conductive fluid that is sufficient to eject a droplet of the fluid through the orifice. Various types of actuation pulses are known in the art. Optionally, an actuation pulse may comprise a plurality of sub pulses. For example, from U.S. Pat. No. 5,377,961 it is known to actuate an electrically conductive fluid by applying positive and negative actuation pulses to the fluid, wherein the positive pulses and the negative pulses interchange. It is described that the positive pulse serves to move a portion of the fluid through the orifice and that the negative pulse serves to move a part of the fluid back towards the fluid reservoir, thereby forming a droplet. Thus, by suitable composing the actuation pulse from a plurality of sub-pulses, a droplet of a suitable size may be ejected. Moreover, other effects, such as satellite droplets may be prevented by suitably composing the actuation pulse. In any case, the actuation pulse should be composed such, that the actuation pulse, in normal operation, provides a net force to the electrically conductive fluid to move through a nozzle away from the fluid chamber.

Also the maintenance pulse may be suitably composed, e.g. from a single negative pulse or from a plurality of sub pulses. By suitably composing the maintenance pulse, the movement of the electrically conductive fluid positioned within the magnetic field as well as the movement of the meniscus of the electrically conductive fluid may be suitably controlled. The maintenance pulse may be composed such that the meniscus of the electrically conductive fluid is retracted upon applying the maintenance pulse. The maintenance pulse may preferably be composed such that no droplet of fluid is expelled upon applying the maintenance pulse.

As mentioned above, the jetting stability may decrease during the jetting process. This may result e.g. in droplets not having the desired size being jetted, droplets not being jetted at a desired jetting angle, or even no droplets being jetted at all upon applying an actuation pulse. In that case, it may be desirable to restore the jetting stability. As describes above, a maintenance pulse may be applied to restore the jetting stability. Preferably, the maintenance pulse may be applied by the same actuation means that apply the actuation pulse to the electrically conductive fluid. Alternatively, separate actuation means, configured to provide a maintenance pulse, may be provided, these actuation means being configured to apply a maintenance pulse to at least a part of the electrically conductive fluid in the part of the chamber provided with the magnetic field. The maintenance pulse may be a single pulse or may comprise a plurality of sub pulses. The sub pulses may be positive sub pulses, negative sub pulses, or a combination thereof. The maintenance pulse may be the inverse of the actuation pulse, but this is not necessary. The maintenance pulse generates a force in the electrically conductive fluid that is directed opposite with respect to the force generated in the electrically conductive fluid by the actuation pulse. The maintenance pulse therefore generates a force in the electrically conductive fluid that is directed in a direction from the orifice of the fluid chamber body to the fluid chamber. When the maintenance pulse is applied to the electrically conductive fluid, and this fluid is positioned in the magnetic field and is in electrically conducting contact with the electrical current generating means, then the fluid experiences a Lorentz force that moves the fluid from the orifice into the fluid chamber. Therefore, a meniscus of the electrically conductive fluid may be retracted into the fluid chamber upon application of the maintenance pulse. In addition, the maintenance may be applied without a droplet being subsequently expelled.

Moreover, because of the force applied to the electrically conductive material, any conductive material, such as the electrically conductive fluid, but also particles of the fluid that have solidified, as well as electrically conductive contaminant present in the vicinity of the orifice may be moved away from the orifice to the fluid chamber body. Moreover, also non-electrically conductive material present in the vicinity of the orifice, may be moved away from the orifice to the fluid chamber body, together with the electrically conductive fluid upon applying an maintenance pulse. Consequently, the application of a maintenance pulse to the electrically conductive may remove impurities in the orifice region that hamper the jetting process. When there is no more material present in the vicinity of the orifice -besides the electrically conductive fluid—the jetting stability may be restored. In this way, applying a maintenance pulse may restore the jetting stability. The maintenance pulse may be applied to the electrically conductive fluid at regular intervals to maintain the jetting stability of the jetting device. Alternatively, the maintenance pulse may be applied to the electrically conductive fluid upon detection of a condition of the jetting device, for example upon detection of malfunctioning of the jetting device, for example blocking of the orifice.

A single maintenance pulse may be applied to the electrically conductive fluid or a sequence of a plurality of maintenance pulses may be applied to the electrically conductive fluid. In the latter case, optionally the condition of the jetting device may be monitored after each maintenance pulse or after a set of maintenance pulses, wherein, depending of the condition of the jetting device, more maintenance pulses may be applied or not.

Please note that it may be possible, depending on the design of the fluid chamber body, to control the maximum distance between the orifice and the electrically conductive fluid that may arise from applying the maintenance pulse. When the electrically conductive fluid, and possibly also other electrically conductive material that is present around the orifice, moves away from the orifice into the fluid chamber, than it may move to a position in the fluid chamber body where it is no longer in electrically conductive contact with the electrical current generating means and/or where it is no longer positioned within the magnetic field. At this point, there will be no more Lorentz force resulting from the maintenance pulse acting within the fluid and there is no more driving force which causes the fluid to move away from the orifice. Therefore, the fluid may not move too far away from the orifice.

When a maintenance pulse configured to retract a meniscus of the electrically conductive fluid into the fluid chamber is applied to the electrically fluid, and the meniscus is retracted, the retraction of the meniscus may result in an air bubble entering the fluid chamber. The presence of air bubbles may give problems regarding jetting stability in known methods for actuating fluids, for example in piezoelectric actuators. However. in case the actuator is a Lorentz actuator, the presence of air may not have the same negative effect on the jetting process as described with respect to the piezoelectric actuator. In devices for jetting an electrically conductive fluid using Lorentz actuation, a force is generated in the form of motion within the fluid itself, provided the fluid is an electrically conductive fluid. Thus, in Lorentz actuation, the Lorentz force generated acts directly on the fluid, without a pressure wave having to be build up. Therefore, even in case an air bubble is formed in the fluid chamber, for example by applying a maintenance pulse, fluid may still be jetted. Moreover, since the flow of the fluid does not need to be restricted, as for example in a piezoelectric actuator, to be able to eject a droplet, a Lorentz actuator may be constructed such that an air bubble entered in the fluid chamber may easily escape, for example by allowing the air bubble to float upwards towards a position outside of the fluid chamber. The escape of an air bubble from the fluid chamber may be facilitated by applying a maintenance pulse, or a series of maintenance pulses, to the electrically conductive fluid. The movement of the fluid away from the orifice, as a result of the maintenance pulse, may induce a movement of the air bubble away from the orifice.

It is also possible to restore the jetting stability of a jetting device, which jets droplets of a fluid using Lorentz actuation by applying a positive purge pulse. A positive purge pulse is a pulse that has a higher amplitude and/or a longer pulse width than an actuation pulse. The positive purge pulse provides a larger Lorentz force to the electrically conductive fluid than an actuation pulse. Therefore, contaminants may be pushed away from the vicinity of the orifice. When the contaminants have been removed, jetting stability may be restored. However, the application of the purge pulse may not always result in restoring the jetting stability.

In addition, applying a positive purge pulse may result in the ejection of contaminants and/or a relatively large amount of fluid, which may end up on the receiving material, thereby negatively influencing the printing quality, when the positive purge pulse is applied during a print job. The positive purge pulse may be applied in between print jobs. However, if the jet stability decreases during a print job, it is desirable to be able to restore the jetting stability immediately, without having to wait for the print job to be finished. These disadvantages are mitigated by applying a maintenance pulse, such as a negative purge pulse, instead of a positive purge pulse. Alternatively, it is possible to restore the jetting stability of a jetting device by applying a combination of positive and negative purge pulses.

In an embodiment the maintenance pulse is provided by generating an inverse electrical current in the electrically conductive fluid in the part of the chamber provided with the magnetic field. As stated above, the direction and the magnitude of the resulting Lorentz force may be suitably selected by suitably selecting the direction and the magnitude of the electric current, as well as the direction and the magnitude of the magnetic field. Thus, the direction of the Lorentz force generated in the electrically conductive fluid may be inverted by inverting the direction of the electrical current applied to the electrically conductive fluid and leaving the direction of the magnetic field unchanged. The actuation means may be used to apply the maintenance pulse to the system. In this embodiment, the electrical current may be inverted, e.g by changing the direction of the current generated by the electrical current generating means.

In an embodiment, the maintenance pulse consists of a single negative pulse. A single negative pulse may suffice to restore the jetting stability.

In an embodiment, a series of maintenance pulses, each of the maintenance pulses consisting of a single negative pulse, may be applied.

In an embodiment, the method further comprises the steps of:
b) detecting a resulting electrical current, which electrical current is induced by a residual force in the part of the conductive fluid positioned in the magnetic field, thereby obtaining a detection signal ; and
c) based on the detection signal determining whether the jetting device is in an operative state,

wherein steps b) and c) are performed after providing an actuation pulse, and wherein, if the jetting device is not in an operative state, step a) is performed.

In the jetting device for jetting a droplet of an electrically conductive fluid in accordance with the present invention, a droplet of said electrically conductive fluid is expelled through an orifice by a Lorentz force. This force causes a motion in the conductive fluid. The Lorentz force is related to the electric current and the magnetic field vector; \vec{F}=\vec{I}×\vec{B}. In the system according to the present invention, the magnetic field is provided and an electrical current is provided in the conductive fluid, such that a suitable force for ejecting a droplet is generated. Before a droplet of fluid is ejected, a motion has been generated in the electrically conductive fluid by the Lorentz force. Due to inertia, the motion within the fluid in the fluid chamber after ejection of the droplet, does not disappear momentarily as soon as the application of the electrical current is stopped, but will gradually fade in the course of time. The residual motion of the fluid in the fluid chamber as a function of time will depend, amongst others, on the acoustic behavior of the fluid chamber. The motion in the conductive fluid generates a force. Thus, after ejection of a droplet, a force is generated in the fluid. Since the conductive fluid is positioned in a magnetic field, an induced current (\vec{I}) is generated in the fluid, because of the relation \vec{F}=\vec{I}×\vec{B}. By measuring this current, hereafter referred to as resulting electric current, a detection signal may be obtained. Based on the detection signal, the acoustics in the actuation chamber may be monitored. A method for monitoring a performance of a jetting device configured to expel droplets of an electrically conductive fluid is described in more detail in WO 2011/113703 A1.

However, also in the case that providing an electrical current in the presence of a magnetic field does not lead to the ejection of a droplet -or in case a droplet is generated that deviates from a normal droplet, e.g. in size or in jetting angle—still the acoustic behavior of the fluid may be monitored. As explained above, applying an electrical current through a conductive fluid in a magnetic field generates a Lorentz force, which results in a residual motion in the conductive fluid that will gradually fade in the course of time. The residual motion as a function of time will depend, amongst others, on the acoustic behavior of the fluid chamber. The acoustic behavior includes inter alia the resonances due to the shape of the fluid chamber and due to the presence or absence of fluid and due to the presence or absence of impurities in the vicinity of the orifice, such as solid particles. Since a magnetic field is applied to the conductive fluid, the force resulting from the residual motion will induce a current through the fluid, in accordance with \vec{F}=\vec{I}×\vec{B}, which may be sensed by suitable means. By measuring this detection signal, the acoustic behavior of the actuation chamber may be monitored and as a consequence, it may be determined whether the jetting device is in an operative state or not.

If the jetting device is not (anymore) in an operative state, it may be desired to restore the jetting stability. Restoring the jetting stability may be performed by applying a maintenance pulse to at least a part of the electrically conductive fluid in the part of the chamber provided with the magnetic field. By applying the maintenance pulse, the jetting stability may be restored, e.g. by removing impurities from the vicinity of the orifice that were hampering the jetting process.

The steps of detecting a resulting electrical current, thereby obtaining a detection signal and determining, based on the detection signal, whether the jetting device is in an operative state or not, may be carried out after applying an actuation pulse. For example, these steps may be carried out during a print job. As mentioned above, applying a maintenance pulse does not result in the jetting of a droplet and therefore, the print result may not be negatively influenced. In addition, by monitoring the jetting stability, it is possible to restore jetting stability before device starts malfunctioning. Consequently, all droplets of the print job may be printed accurately, resulting in good print quality.

Steps b) and c) may be carried out continuously, or alternatively, they may be carried out at less frequently, for example in between print jobs or after a plurality of print jobs.

In an aspect of the invention, the present invention further provides a jetting device for jetting a droplet of an electrically conductive fluid, the jetting device comprising:
a fluid chamber body defining a fluid chamber and having an orifice extending from the fluid chamber to an outer surface of the fluid chamber element, the fluid chamber being configured for holding an amount of the electrically conductive fluid; and
an actuation means configured to provide an actuation pulse for expelling droplets of the electrically conductive fluid from the fluid chamber through the orifice, the actuation means comprising:
a magnetic field generating means for generating a magnetic field in at least a part of the fluid chamber; and
an electrical current generating means for generating an electrical current in the electrically conductive fluid in the part of the fluid chamber provided with the magnetic field,
the actuation means being further configured to provide a maintenance pulse for retracting the meniscus of the electrically conductive fluid into the fluid chamber.

The jetting device according to the present invention is thus configured for performing the method according to the present invention.

The actuation means may be efficiently embodied as being configured to provide both the actuation pulse for expelling droplets of the electrically conductive fluid from the fluid chamber through the orifice, an the maintenance pulse for retracting the meniscus of the electrically conductive fluid into the fluid chamber. Alternatively, means for providing the actuation pulse and means for providing the maintenance pulse not be embodied together. In that case, both the actuation means and the means for applying the maintenance pulse may comprise electrical current generating means and magnetic field generating means.

### BRIEF DESCRIPTION OF THE DRAWINGS

These and further features and advantages of the present invention are explained hereinafter with reference to the accompanying drawings showing non-limiting embodiments and wherein:

FIG. 1 shows a perspective view of a printing device for printing droplets of an electrically conductive fluid.

FIG. 2 shows a cross-sectional view of a part of the printing device shown in FIG. 1.

FIG. 3A and FIG. 3B show a number of examples of actuation pulses.

FIG. 4A and FIG. 4B show a number of examples of maintenance pulses.

In the drawings, same reference numerals refer to same elements.

### DETAILED DESCRIPTION OF THE DRAWINGS

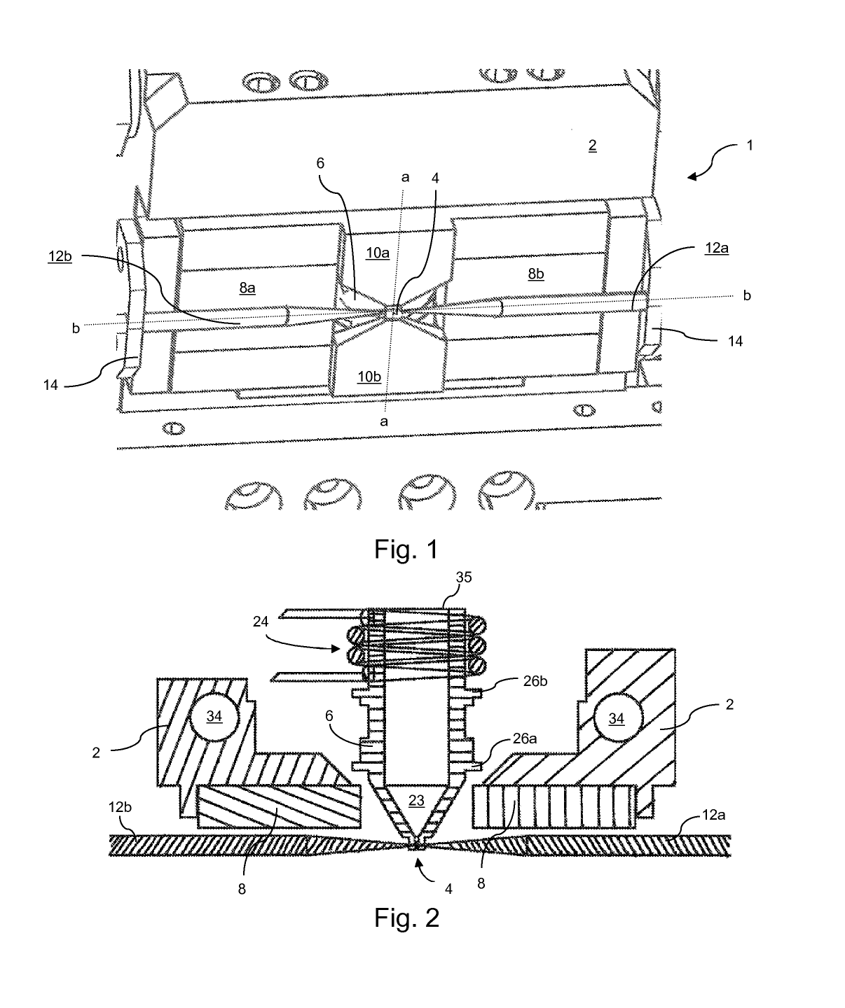

FIG. 1 shows a part of a jetting device 1 for ejecting droplets of an electrically conductive fluid, in particular a molten metal such as copper, silver, gold and the like. The jetting device 1 comprises a support frame 2. Molten metals such as copper, silver, gold, or molten semiconductors are generally materials having a high melting point. Therefore, in the molten state, such molten metals or semiconductors may be relatively hot fluids. Therefore, the support frame 2 is preferably made of a heat resistant and heat conductive material.

The jetting device 1 is provided with an ejection orifice 4 through which a droplet of the fluid may be ejected. The orifice or nozzle 4 is a through hole extending through a wall of a fluid chamber body 6. In the fluid chamber body 6 a fluid chamber is arranged. The fluid chamber is configured to hold the electrically conductive fluid.

For ejecting droplets of the electrically conductive fluid, the jetting device 1 is provided with two permanent magnets 8a, 8b (hereinafter also referred to as magnets 8). The magnets 8 are arranged between two magnetic field concentrating elements 10a, 10b (hereinafter also referred to as concentrators 10) made of magnetic field guiding material such as iron. The jetting device 1 is further provided with two electrodes 12a, 12b (hereinafter also referred to as electrodes 12) both extending into the fluid chamber body 6 through a suitable through hole such that at least a tip of each of the electrodes 12 is in direct electrical contact with the molten metal present in the fluid chamber. The electrodes 12 are supported by suitable electrode supports 14 and are each operatively connectable to a suitable electrical current generator (not shown) such that a suitable electrical current may be generated through the electrodes 12 and the molten metal present between the tips of the electrodes 12. The electrodes 12 may be each operatively connectable to an electrical signal detection unit (not shown), such that a resulting current, induced by a residual pressure wave in the part of the fluid positioned in the magnetic field, may be monitored.

In the jetting device 1 as shown in FIG. 1, the magnets 8, the concentrators 10 and the electrodes 12 are configured to apply an actuation pulse to the electrically conductive fluid, as well as to provide a maintenance pulse to the fluid.

FIG. 2 shows a cross-section of the embodiment illustrated in FIG. 1, which cross-section is taken along line b-b (FIG. 1). Referring to FIG. 2, the support frame 2 and the magnets 8 are shown. In the illustrated embodiment, the support frame 2 is provided with cooling channels 34 through which a cooling liquid may flow for actively cooling of the support frame 2 and the magnets 8. An induction coil 24 is shown. The fluid chamber body 6 is arranged in a centre of the induction coil 24 such that a current flowing through the induction coil 24 results in heating of a metal arranged in the fluid chamber 6. Due to such heating the metal may melt and thus become a fluid. Such inductive heating ensures a power-efficient heating and no contact between any heating element and the fluid, limiting a number of (possible) interactions between elements of the jetting device 1 and the fluid. Nevertheless, in other embodiments, other means for heating the metal, or another electrically conductive fluid, in the fluid chamber may be applied.

The fluid chamber body 6 of the jetting device as depicted in FIG. 2 has an open connection 35 to the environment at the top of the fluid chamber body. Because of this open connection, air bubbles or gas bubbles that may have entered the fluid chamber 23, for example air or gas bubbles that have entered the fluid chamber 23 upon applying an maintenance pulse, may leave the fluid chamber 23 and the fluid chamber body 6 via the open connection 35 to the environment.

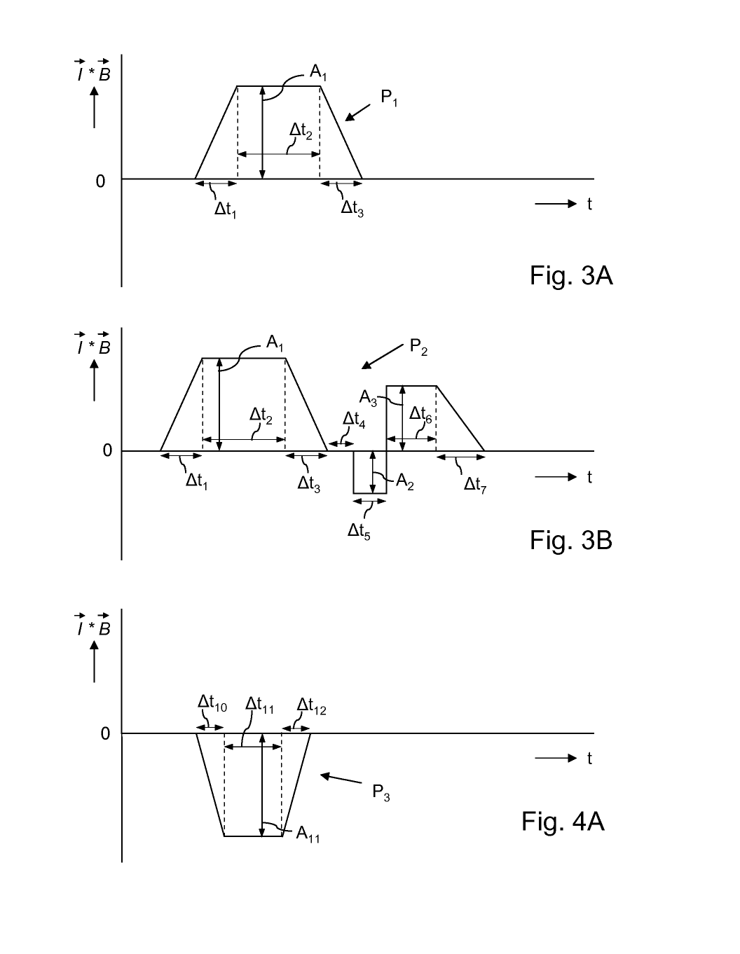

FIG. 3A-3B show a number of examples of actuation pulses as may be generated by an actuation means in a conductive fluid in a fluid chamber body. FIG. 3A shows an actuation pulse P₁ that consists of a single positive pulse. The actuation pulse is the magnitude of \vec{I}×\vec{B} as a function of time, during the pulse length. The total pulse length of the actuation pulse P₁ is Δt₁+Δt₂+Δt₃. The total pulse length Δt₁+Δt₂+Δt₃ may be in the range of 2 μs to 250 μs. During a first period of time Δtₜ, the amplitude of the pulse gradual increases, thereby applying a gradually increasing force (\vec{F}=\vec{I}×\vec{B}) to the electrically conductive fluid, until the maximum amplitude A₁ is reached. During a second period of time Δt₂, the magnitude of the force applied to the electrically conductive fluid is constant and has a magnitude A₁. After the expiry of the second period of time Δt₂, there is a third period of time Δt₃, wherein the magnitude of the force applied to the electrically conductive fluid gradually decreases until it becomes zero. The length of the periods of time Δt₁, Δt₂, Δt₃ may vary. In an alternative embodiment, the actuation pulse may be a step function. In that case, the first and third periods of time Δt₁, Δt₃ are zero are almost zero.

FIG. 3B shows an actuation pulse P₂ that consists of a plurality of sub pulses. During a period of time Δt₁+Δt₂+Δt₃, a first sub pulse is applied to the electrically conductive fluid. This first sub pulse is a positive sub pulse during which a positive force is applied to the electrically conductive fluid. This positive force may result in the ejection of a part of the fluid through the orifice. After the first sub pulse has been applied to the fluid, during a fourth period of time Δt₄, there is an optional pause in the actuation pulse, during which no force is applied to the fluid by the actuation means. However, a residual force, resulting from the Lorentz force applied to the electrically conductive fluid may be present and cause motions within the fluid during the fourth period of time Δtₜ. The pause in the actuation pulse is optional; therefore, the fourth period of time may be 0. During a period of time Δt₆ a second sub pulse is applied to the system. The second sub pulse is a negative sub pulse during which a negative force is applied to the electrically conductive fluid. The negative sub pulse is shown as a step shaped pulse. However, the negative sub pulse may have any suitable shape. For example, the decrease and/or the increase of the force applied to the fluid may be gradual. The negative sub pulse generates a force in the electrically conductive fluid having a direction opposite with respect to the force applied to the fluid by the positive sub pulse. This results in the retraction of (a part of the fluid) into the fluid chamber. This may be used for example to control the size of a droplet ejected by the jetting device.

Finally, during a period of time Δt₆+Δt₇, a third sub pulse is applied to the fluid, the third sub pulse being a positive sub pulse. The third sub pulse, as depicted in FIG. 3B shows a instantaneous incline to a pulse having a magnitude corresponding to the amplitude Δ₃. After a sixth period of time Δt₆ wherein a constant force is applied to the fluid, the force gradually decreases to 0 during a seventh period of time Δ₇. The third sub pulse may be applied to the fluid, for example to stabilise a meniscus of the fluid.

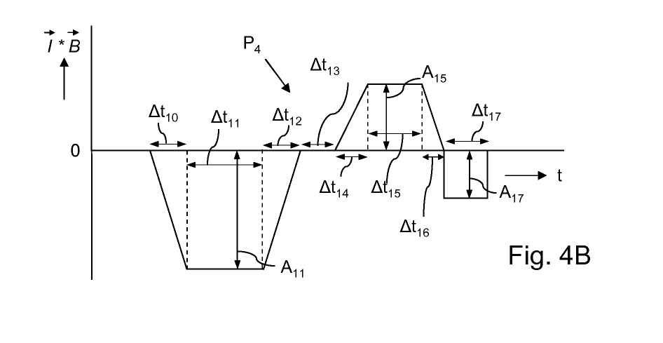

FIG. 4A and FIG. 4B show a number of examples of maintenance pulses as may be generated by an actuation means in a conductive fluid in a fluid chamber body. FIG. 4A shows an maintenance pulse P₃ that consists of a single negative pulse. The total pulse length of the actuation pulse P₁ is Δt₁₀+Δt₁₁+Δt₁₂. The total pulse length Δt₁₀+Δt₁₁+Δt₁₂ may be in the range of 5 μs to 250 μs. During an tenth period of time Δt₁₀, the amplitude of the pulse gradually increases, thereby applying a gradually increasing negative force (\vec{F}=\vec{I}×\vec{B}) to the electrically conductive fluid, until the maximum amplitude A₁ is reached. During a eleventh period of time Δt₁₁, the magnitude of the force applied to the electrically conductive fluid is constant and has a magnitude Δ₁₁. After the expiry of the second period of time Δt₁₁, there is a twelfth period of time Δt₁₂, wherein the magnitude of the force applied to the electrically conductive fluid gradually decreases until it becomes zero.

The length of the periods of time Δt₁₀+Δt₁₁+Δt₁₂ may vary. In an alternative embodiment, the actuation pulse may be a step function. In that case, the tenth and twelfth periods of time Δt₁₀, Δt₁₂ are zero. During the maintenance pulse, a force is generated in the fluid and optionally, within electrically conductive contaminant present in the vicinity of the orifice. The pulse may therefore result in the electrically conductive fluid and/or the electrically conductive contaminant present in the vicinity of the orifice moving from the orifice into the fluid chamber. In this way, the orifice and its vicinity may be cleaned from contaminants and the jetting stability may be restored.

FIG. 4B shows an maintenance pulse P₄ that consists of a plurality of sub pulses. During a period of time Δt₁₀+Δt₁₁+Δt₁₂, a first sub pulse is applied to the electrically conductive fluid by the inverse actuation means (not shown). The inverse actuation means may be the actuation means. This first sub pulse is a negative sub pulse during which a negative force is applied to the electrically conductive fluid. This negative force may result in the movement of (a part of) the fluid from the orifice into the fluid chamber. Optionally, contaminants, both electrically conductive and non-electrically conductive contaminants, or air bubbles, may move with the fluid away from the orifice into the fluid chamber. After the first sub pulse has been applied to the fluid, during a thirteenth period of time Δt₁₃, there is an optional pause in the actuation pulse, during which no force is applied to the fluid by the inverse actuation means. However, a residual force, resulting from the Lorentz force applied to the electrically conductive fluid may be present and cause motions within the fluid during the thirteenth period of time Δt₁₃. The pause in the actuation pulse is optional. Therefore, the thirteenth period of time may be zero.

During a period of time Δt₁₄+Δt₁₅+Δt₁₆ a second sub pulse is applied to the system. The second sub pulse is a positive sub pulse during which a positive force is applied to the electrically conductive fluid. The positive sub pulse is shown as a pulse showing a gradual increase and a gradual decrease in amplitude. However, the positive sub pulse may have any suitable shape. For example, the sub pulse may be the shape of a step function. The positive sub pulse generates a force in the electrically conductive fluid having a direction opposite with respect to the force applied to the fluid by the negative sub pulse. Finally, during a period of time Δt₁₇, a third sub pulse is applied to the fluid, the third sub pulse being a negative sub pulse. The third sub pulse, as depicted in FIG. 4B shows a instantaneous incline to a pulse having a magnitude corresponding to the amplitude A₁₇. The second and/or third sub pulse may be applied to the fluid, for example to stabilise a meniscus of the fluid.

Detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually and appropriately detailed structure. In particular, features presented and described in separate dependent claims may be applied in combination and any combination of such claims are herewith disclosed. Further, the terms and phrases used herein are not intended to be limiting; but rather, to provide an understandable description of the invention. The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language).

1. Method for maintaining jetting stability in a jetting device for jetting a droplet of an electrically conductive fluid, the jetting device comprising a fluid chamber body defining a fluid chamber and having an orifice extending from the fluid chamber to an outer surface of the fluid chamber element and an actuation means, the actuation means comprising:
a magnetic field generating means for generating a magnetic field in at least a part of the fluid chamber; and
an electrical current generating means for generating an electrical current in the electrically conductive fluid in the part of the fluid chamber provided with the magnetic field,
the actuation means being configured to provide an actuation pulse for expelling droplets of the electrically conductive fluid from the fluid chamber through the orifice, the actuation means being further configured to provide a maintenance pulse, the actuation pulse and the maintenance pulse each generating a Lorentz force in the conductive fluid in said part of the fluid chamber,
the method comprising the step of:
a) applying the maintenance pulse to at least a part of the electrically conductive fluid in the part of the chamber provided with the magnetic field, the maintenance pulse being configured to retract a meniscus of the electrically conductive fluid into the fluid chamber.

2. Method according to claim 1, wherein the maintenance pulse is provided by generating an inverse electrical current in the electrically conductive fluid in the part of the chamber provided with the magnetic field.

3. Method according to claim 1, wherein the maintenance pulse consists of a single negative pulse.

4. Method according to claim 1, wherein the method further comprises the steps of:
b) detecting a resulting electrical current, which electrical current is induced by a residual force in the part of the conductive fluid positioned in the magnetic field, thereby obtaining a detection signal; and
c) based on the detection signal determining whether the jetting device is in an operative state,
wherein steps b) and c) are performed after providing an actuation pulse, and wherein, if the jetting device is not in an operative state, step a) is performed.

5. Jetting device for jetting a droplet of an electrically conductive fluid, the jetting device comprising:
a fluid chamber body defining a fluid chamber and having an orifice extending from the fluid chamber to an outer surface of the fluid chamber element, the fluid chamber being configured for holding an amount of the electrically conductive fluid; and
an actuation means configured to provide an actuation pulse for expelling droplets of the electrically conductive fluid from the fluid chamber through the orifice, the actuation means comprising:
a magnetic field generating means for generating a magnetic field in at least a part of the fluid chamber; and
an electrical current generating means for generating an electrical current in the electrically conductive fluid in the part of the fluid chamber provided with the magnetic field,
the actuation means being further configured to provide a maintenance pulse for retracting the meniscus of the electrically conductive fluid into the fluid chamber.
